(19) United States
(12) Patent Application Publication
(10) Pub. No.: US 2016/0225041 A1
(43) Pub. Date: Aug. 4, 2016

(54) Flow-Sorting System

(71) Applicant: NEOPOST TECHNOLOGIES, Bagneux (FR)

(72) Inventor: Daniel Albu, Kirkland, WA (US)

(21) Appl. No.: 14/610,575

(22) Filed: Jan. 30, 2015

(51) Int. Cl. G06Q 30/02; B07C 5/34

(52) U.S. Cl. CPC G06Q 30/0283; B07C 5/34; G06Q 2250/50

(57) ABSTRACT

A system and method are provided to determine in order, what mailing pieces are eligible for Flat Sequence Sorter (FSS) preparation, determine applicable prices of the pieces, and prepare bundles of the pieces to conform to the expected USPS output. By orderly implementing a filtering operation wherein FSS and Non-FSS pieces are first identified, followed by a pricing operation for groups with a very granular level (HDP) and the best price, to groups with a very coarse level (3D), and then creating bundles, pallets or containers, sacks, trays or handling units, of the FSS and Non-FSS pieces based thereon, the system and method identifies the best possible pricing for a mailing, while ensuring that the final mailing is compliant with U.S. Postal Service, Domestic Mail Manual, Section 705.

### BACKGROUND

As noted in U.S. Postal Service, Domestic Mail Manual, Section 705, the entire content of which is incorporated herein by reference, presorted and basic carrier route standard mail flats, and all bound printed matter (BPM) presorted and carrier route flats and periodicals flats meeting the standards in 201.6.2, must be consolidated into 5-digit Flat Sequence Sorter (FSS) scheme bundles and placed on pallets or containers, in sacks and trays or handling units, or in approved alternate containers, for 5-digit FSS scheme ZIP Code combinations within the same facility. Mailings that include 10 or more pieces of standard mail flats, 6 or more pieces of periodicals flats or 10 or more pieces (or 10 or more pounds) of BPM flats to a FSS scheme, must be prepared in FSS scheme bundles for that 5-digit FSS scheme.

Mailers may optionally prepare scheme pools with less than those minimums and may prepare an FSS scheme bundle if there is a minimum of 3 inches per bundle. Mailings of nonpresorted BPM flats may be included in FSS preparation, but will not be eligible for presorted or carrier route prices. The Postal Service also recommends the use of flat trays in lieu of sacks for FSS bundles. Bundles of flats prepared to FSS zones also may be combined with bundles of flats not intended for FSS processing when prepared to less finely presorted containers in accordance with these standards and the standards in 8.0.

Mailers currently place qualifying mailpieces from all price categories into a separate combined pool for each individual 5-digit FSS-scheme combination, and then prepare bundles of uniform size from those pieces. Mailpieces that meet the eligibility standards for 5-digit prices, basic and high-density carrier route prices, or BPM presort or carrier route prices will continue to be eligible for these prices when prepared in accordance with the FSS preparation standards. Saturation price standard mail and periodicals flats are not eligible for preparation under this option. High-density and high-density plus standard mail flats that meet the physical requirements in 201.6.0 may be included when prepared in accordance with these standards.

However, it can be difficult to quickly and accurately determine the best possible pricing for the mailing, while ensuring that the final mailing is USPS compliant.

### BRIEF SUMMARY

According to an embodiment of the disclosed subject matter, a system and method is provided to quickly and accurately determine the best possible pricing for a mailing, while ensuring that the final mailing is compliant with U.S. Postal Service, Domestic Mail Manual, Section 705.

According to an embodiment of the disclosed subject matter, a system and method is provided for filtering mail pieces into FSS and Non-FSS pieces.

According to an embodiment of the disclosed subject matter, a system and method is provided for pricing mail pieces, including FSS, Non-FSS, and combinations of FSS and Non-FSS pieces.

According to an embodiment of the disclosed subject matter, a system and method is provided for placing FSS, Non-FSS, and combinations of FSS and Non-FSS pieces into bundles, pallets or containers, sacks, trays or handling units, or other containers.

According to an embodiment of the disclosed subject matter, means for filtering mail pieces into FSS and Non-FSS pieces are provided.

According to an embodiment of the disclosed subject matter, means for pricing mail pieces, including FSS, Non-FSS, and combinations of FSS and Non-FSS pieces are provided.

According to an embodiment of the disclosed subject matter, means for placing FSS, Non-FSS, and combinations of FSS and Non-FSS pieces into bundles, pallets or containers, sacks, trays or handling units, or other containers are provided.

According to an embodiment of the disclosed subject matter, when the user has a mailing job where the mail type is flats and mail class is either standard, periodicals or bound printed matter, the system and method directs the operation of hardware, software, and combinations of hardware and software, to determine in order, what mailing pieces are eligible for FSS preparation, determine applicable prices of the pieces, and prepare bundles of the pieces to conform to the expected USPS output. By orderly implementing a filtering operation wherein FSS and Non-FSS pieces are first identified, followed by a pricing operation for groups with a very granular level (HDP) and the best price, to groups with a very coarse level (3D), and then creating bundles, pallets or containers, and sacks, trays or handling units, of the FSS and Non-FSS pieces based thereon, the system and method identifies the best possible pricing for a mailing, while ensuring that the final mailing is compliant with U.S. Postal Service, Domestic Mail Manual, Section 705.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 is a flow chart illustrating a filtering process according to an embodiment of the disclosed subject matter.

FIG. 2 is a flow chart illustrating a pricing process for identifying groups and prices of groups for pieces that are eligible for FSS preparation according to an embodiment of the disclosed subject matter.

FIG. 3 is a flow chart illustrating a bundling process for bundling both groups that are eligible for FSS preparation, and groups that are not eligible for FSS preparation, according to an embodiment of the disclosed subject matter.

FIGS. 4A and 4B is a flow chart illustrating more specifically an FSS preparation according to an embodiment of the disclosed subject matter.

FIGS. 5A and 5B is a flow chart illustrating more specifically a detailed pallet preparation according to an embodiment of the disclosed subject matter.

FIG. 6 is a flow chart illustrating more specifically a detailed sack and/or tray preparation according to an embodiment of the disclosed subject matter.

FIGS. 7A and 7B is a flow chart illustrating more specifically a detailed pricing process for standard mail according to an embodiment of the disclosed subject matter.

FIGS. 8A and 8B is a flow chart illustrating more specifically a detailed pricing process for periodicals addressed in-county according to an embodiment of the disclosed subject matter.

FIGS. 9A and 9B is a flow chart illustrating more specifically a detailed pricing process for periodicals addressed outside-county according to an embodiment of the disclosed subject matter.

FIG. 10 is a flow chart illustrating more specifically a detailed pricing process for periodicals containers according to an embodiment of the disclosed subject matter.

FIG. 11 is a flow chart illustrating more specifically a detailed pricing process for bound printed matter according to an embodiment of the disclosed subject matter.

### DETAILED DESCRIPTION

According to an embodiment of the disclosed subject matter, when a user has a mailing job where the mail type is flats and mail class is either standard, periodicals or bound printed matter, the system and method directs the operation of hardware, software, and combinations of hardware and software, to determine in order, what mailing pieces are eligible for Flat Sequence Sorter (FSS) preparation, determine applicable prices of the pieces, and prepare bundles of the pieces to conform to the expected USPS output. By orderly implementing a filtering operation wherein FSS and Non-FSS pieces are first identified, followed by a pricing operation for groups with a very granular level (HDP) and the best price, to groups with a very coarse level (3D), and then creating bundles, pallets or containers, and sacks, trays or handling units, of the FSS and Non-FSS pieces based thereon, the system and method identifies the best possible pricing for a mailing, while ensuring that the final mailing is compliant with U.S. Postal Service, Domestic Mail Manual, Section 705. This is an exemplary operation, and where additional restrictions apply for claiming HDP and HD prices, combinations can be created in compliance with the additional restrictions if desirable to do so.

According to an embodiment of the disclosed subject matter, the process may perform 3 operations, wherein an order of operations may be varied as desired and steps therein may be combined, omitted or arranged as desired. First, the invention performs a filtering process to filter out all of the pieces that are not eligible for FSS preparation. To do so, the invention checks data of the pieces, such as but not limited to the destination zip code for each piece, and eliminates the pieces that are not going to a ZIP code that is covered by an FSS scheme machine, pieces that qualify for Walk Sequence Saturation rates, pieces that are eligible for a Destination Delivery Unit (DDU) discount, pieces that are part of a Firm Bundle (in this case, periodicals only, but the invention is not limited thereto), and pieces that qualify for In-County rates (in this case, periodicals only, but the invention is not limited thereto).

Next, remaining pieces that qualify, are grouped following certain criteria to determine the price level. The groups are formed ranging from a very granular level (HDP) and the best price, to a very coarse level (3D). These groups are not real groups (i.e., bundles), but are only used to determine the optimum price levels following the filtering process and prior to the creation of bundles, pallets or containers, and sacks, trays or handling units. At this point, the user can exclude HDP and/or HD eligible pieces to achieve an optimum price.

Finally, after the optimum prices are calculated for each piece of the groups, physical bundles are prepared for each individual FSS scheme. By filtering and pricing the pieces prior to actually creating physical bundles for each individual FSS scheme, the invention identifies the best possible pricing for a mailing, while ensuring that the final mailing is compliant with U.S. Postal Service, Domestic Mail Manual, Section 705. That is, once all the pieces are created, FSS sacks, FSS Scheme pallets and FSS Facility pallets are created. As a further improvement, if there are not enough FSS bundles to satisfy the minimum requirements for the containers, the FSS bundles are put to the side, but are not broken out. The non-FSS pieces that were filtered out are bundled separately, following the pre-FSS preparation rules, and are combined with the FSS bundles that could not fit in FSS containers, and are then added to the correct containers, sacks and/or pallets. By using such a system and method, a customer gets the best possible price for the mailing, which is also USPS compliant. Further, efficiency is maximized by setting aside the FSS bundles that could not fit in FSS containers and then combining them with non FSS bundles in the right containers.

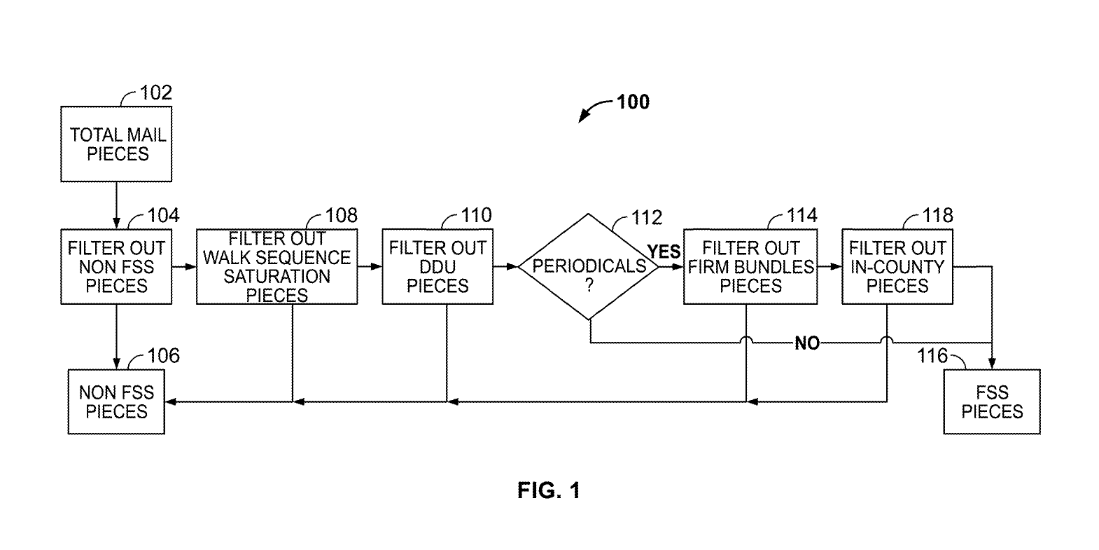

As noted above, in a first phase, a filtering operation is performed as illustrated in the flow chart of FIG. 1. The invention filters out all of the pieces that are not eligible for FSS preparation. The invention checks at least the destination zip code for each piece and eliminates the pieces that are not going to a ZIP code that is covered by an FSS scheme machine, pieces that qualify for Walk Sequence Saturation rates, pieces that are eligible for a DDU discount, pieces that are part of a Firm Bundle (Periodicals only), and pieces that qualify for In-County rates (Periodicals only). FIG. 1 is a flow chart illustrating a filtering process 100 for identifying pieces that are not eligible for FSS preparation according to an embodiment of the disclosed subject matter. A total number of mail pieces is first determined at step 102, and non-FSS pieces are filtered out at step 104. In each of the steps, identification of the piece is performed using sensors, detectors or other technologies as known to those skilled in the art. Accordingly, details of the sensors and detectors are omitted from this description for clarity.

The non-FSS pieces filtered out at step 104 are directed out of the process at step 106. The remaining pieces that are eligible for FSS preparation are further filtered, and Walk Sequence Saturation pieces are filtered out at step 108. The Walk Sequence Saturation pieces filtered out at step 108 are directed out of the filtering process at step 106. The remaining pieces that are eligible for FSS preparation are further filtered, and DDU pieces are filtered out at step 110. The DDU pieces filtered out at step 110 are directed out of the Filtering process at step 106.

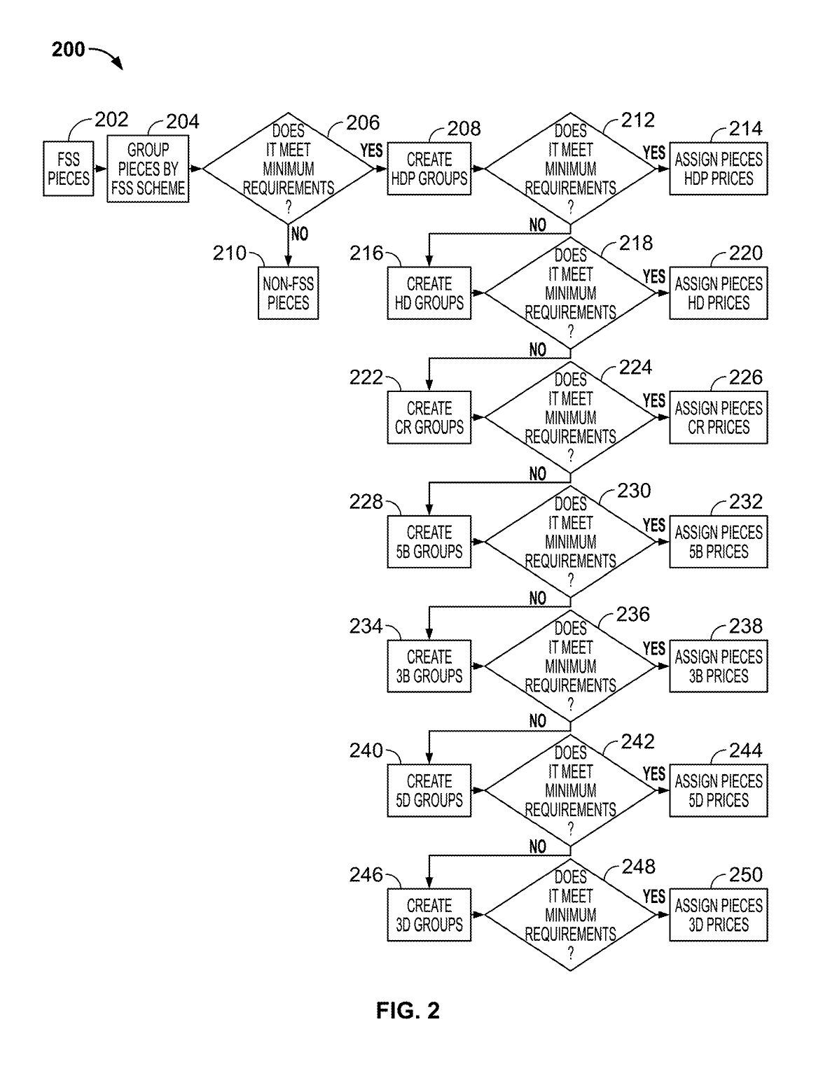

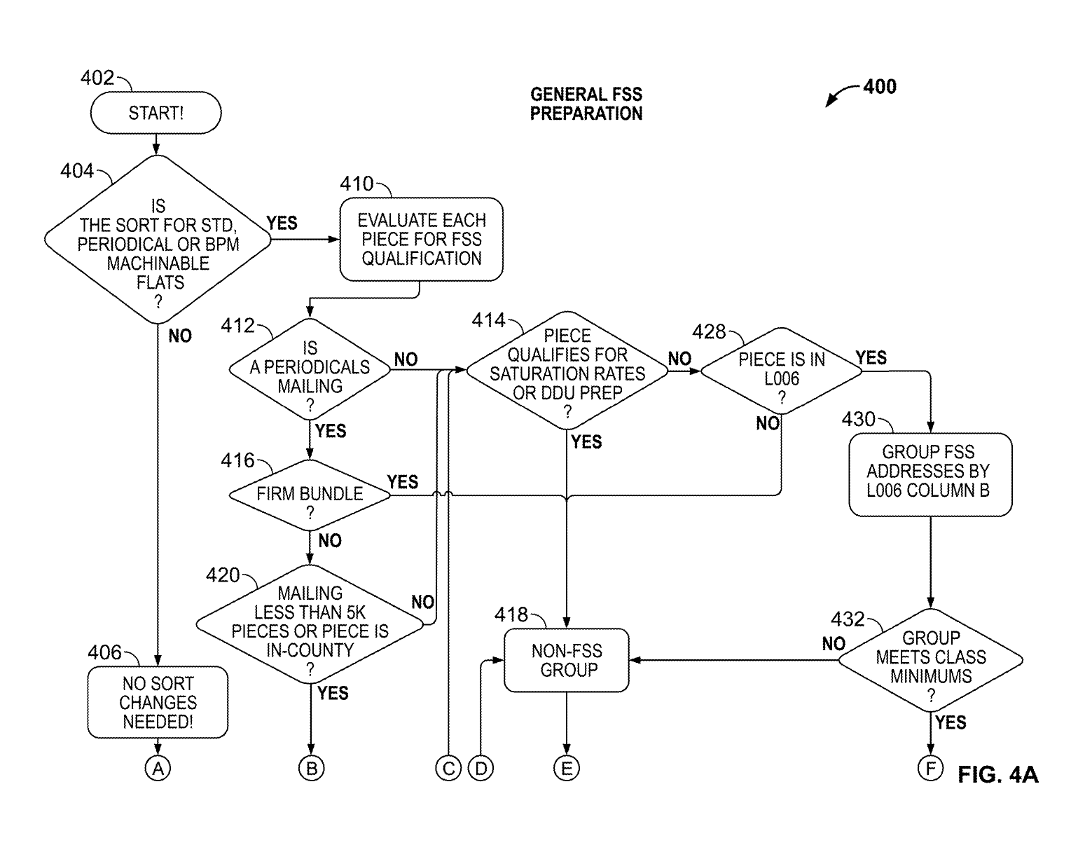

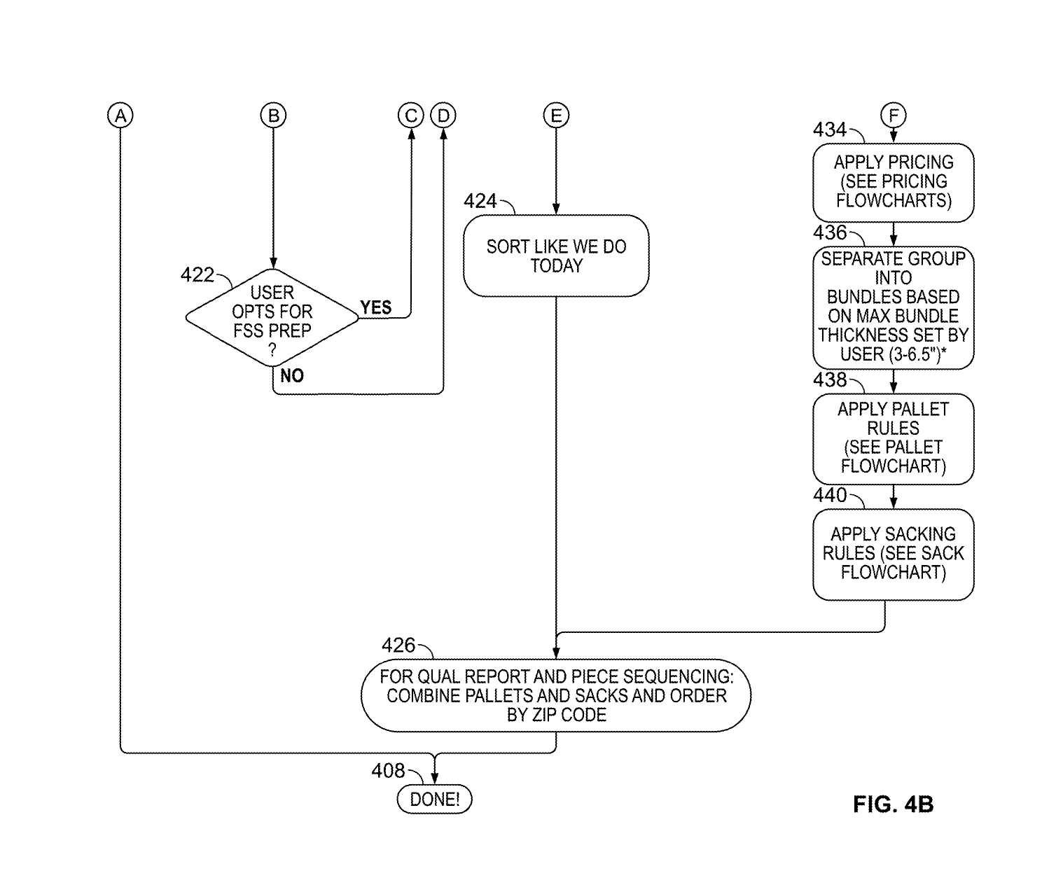

The remaining pieces are evaluated to separate periodicals at step 112, wherein periodicals and other remaining pieces are further filtered, and Firm Bundle pieces are filtered out at step 114. The Firm Bundle pieces filtered out at step 114 are directed out of the filtering process at step 106. The remaining pieces that are eligible for FSS preparation are further filtered, and In-County pieces are filtered out at step 118. The In-County pieces filtered out at step 118 are directed out of the filtering process at step 106. The remaining pieces that are eligible for FSS preparation are directed out of the filtering process at step 116 and to the pricing process of FIG. 2, described in greater detail below. Where no periodicals are detected at step 112, the remaining pieces are also directed out of the filtering process at step 116 and to the pricing process of FIG. 2. A more detailed description of the filtering process is shown in FIGS. 4A and 4B. As noted above, the user can exclude eligible pieces at this point to later achieve an optimum price.

In a second phase, a pricing operation is performed as illustrated in the flow chart of FIG. 2. Pieces need to be grouped following certain criteria to determine the optimum price level for each prior to forming bundles. The present invention creates pricing groups from a very granular level (HDP) and the best price, to a very coarse level (3D). These groups are not real groups (bundles), but are only used to determine the price levels.

FIG. 2 is a flow chart illustrating a pricing process 200 for identifying groups and prices of groups for pieces that are eligible for FSS preparation according to an embodiment of the disclosed subject matter. A total number of mail pieces that are eligible for FSS preparation are directed out of the filtering process at step 116 and into the pricing process of FIG. 2 at step 202. The mail pieces that are eligible for FSS preparation are first grouped by FSS Scheme at step 204, and each group is evaluated to determine if the group meets a minimum requirement. For illustration, such minimum requirements can simply determine if the group can be expected fit into any FSS Scheme later identified, but embodiments are not limited thereto. The pieces filtered out at step 206 are directed out of the pricing process as non-FSS pieces at step 210.

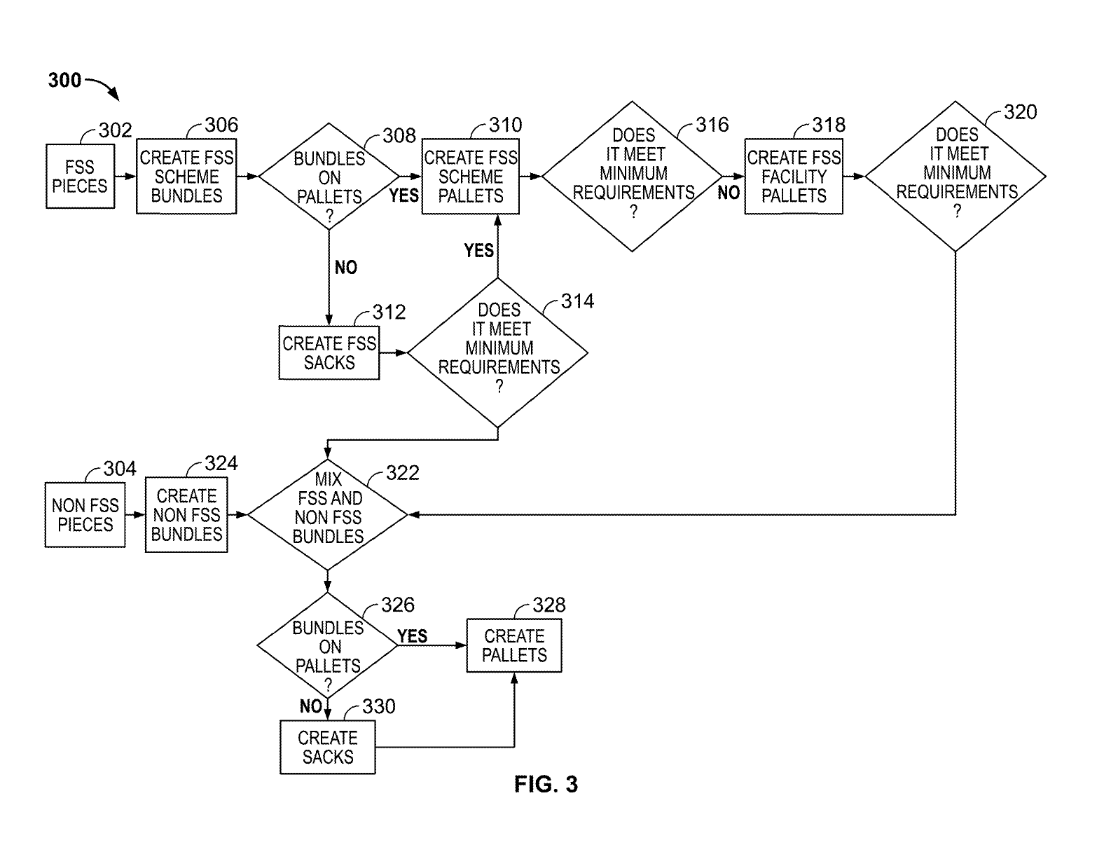

The remaining pieces that are eligible for pricing are further grouped into potential High-Density Pricing (HDP) groups at step 208, and each group is evaluated to determine if the group meets a minimum requirement for an HDP group at step 212. Where the group meets the minimum requirement for an HDP group, the invention assigns HDP prices to the pieces at step 214 and are directed out of the pricing process and to the bundling process of FIG. 3, described in greater detail below. Where the group does not meet the minimum requirement for an HDP group, the remaining pieces are grouped into potential High-Density (HD) groups at step 216, and each group is evaluated to determine if the group meets a minimum requirement for an HD group at step 218. Where the group meets the minimum requirement for an HD group, the invention assigns HD prices to the pieces at step 220 and are directed out of the pricing process and to the bundling process of FIG. 3.

Where the group does not meet the minimum requirement for an HD group, the remaining pieces are grouped into potential CR groups at step 222, and each group is evaluated to determine if the group meets a minimum requirement for a CR group at step 224. Where the group meets the minimum requirement for a CR group, the invention assigns CR prices to the pieces at step 226 and are directed out of the pricing process and to the bundling process of FIG. 3. Where the group does not meet the minimum requirement for a CR group, the remaining pieces are grouped into potential BarCoded 5-Digit (5B) groups at step 228, and each group is evaluated to determine if the group meets a minimum requirement for a 5B group at step 230. Where the group meets the minimum requirement for a 5B group, the invention assigns 5B prices to the pieces at step 232 and are directed out of the pricing process and to the bundling process of FIG. 3. As noted above, the user can exclude eligible pieces at this point to achieve an optimum price. Further, where a process of grouping pieces for basic Carrier Route (CR) rates, 5-Digit rates or 3-Digit rates cannot be applied for compliance or other reasons, the steps can be omitted without affecting remaining processes.

Where the group does not meet the minimum requirement for a 5B group, the remaining pieces are grouped into potential BarCoded 3-Digit 3B groups at step 234, and each group is evaluated to determine if the group meets a minimum requirement for a 3B group at step 236. Where the group meets the minimum requirement for a 3B group, the invention assigns 3B prices to the pieces at step 238 and are directed out of the pricing process and to the bundling process of FIG. 3. Where the group does not meet the minimum requirement for a 3B group, the remaining pieces are grouped into potential 5-Digit (5D) groups at step 240, and each group is evaluated to determine if the group meets a minimum requirement for a 5D group at step 242. Where the group meets the minimum requirement for a 5D group, the invention assigns 5D prices to the pieces at step 244 and are directed out of the pricing process and to the bundling process of FIG. 3.

Where the group does not meet the minimum requirement for a 5D group, the remaining pieces are grouped into potential 3-Digit (3D) groups at step 246, and each group is evaluated to determine if the group meets a minimum requirement for a 3D group at step 248. Where the group meets the minimum requirement for a 3D group, the invention assigns 3D prices to the pieces at step 250 and are directed out of the pricing process and to the bundling process of FIG. 3. A more detailed description of the pricing process is shown in FIGS. 4 and 7-11.

In a third phase, a bundling operation is performed as illustrated in the flow chart of FIG. 3. After the optimum prices are calculated for each piece in FIG. 2, the invention starts creating physical bundles for each individual FSS scheme, and can take into consideration other factors that affect optimum pricing. For example, FSS bundle thickness can be varied based on the container level for periodical mail. In Periodicals, to truly optimize postage, the system may direct the creation of 6 inch bundles because one component of the total postage cost is the number of bundles created for the mailing. However, the reality of processing FSS bundles is that 6 inch bundles are likely to break during processing, and bundle breakage adds significant cost to the Postal Service. Accordingly, embodiments of the disclosed subject matter can further optimize postage by directing the creatation of 6 inch FSS bundles when the bundles are put onto an FSS Scheme pallet or container, and directing the later recreation of 4 inch bundles to reach an optimum balance between minimizing postage and minimizing bundle breakage.

Once all of the bundles are created, the invention starts creating FSS sacks, FSS Scheme pallets and FSS Facility pallets. If there are not enough FSS bundles to satisfy the minimum requirements for the containers, the FSS bundles are put to the side, but are not broken out. Then, the non-FSS pieces that were filtered out at step 106 in FIG. 1 and at step 210 in FIG. 2 are bundled separately, following the pre-FSS preparation rules, and are combined with the FSS bundles, and added to the correct containers, sacks and/or pallets.

FIG. 3 is a flow chart illustrating a bundling process 300 for bundling both groups that are eligible for FSS preparation, and groups that are not eligible for FSS preparation, according to an embodiment of the disclosed subject matter. A total number of mail pieces that are eligible for FSS preparation are directed out of the pricing process and into the bundling process of FIG. 3 at step 302. A total number of mail pieces that are not eligible for FSS preparation are directed out of the filtering process at step 106 and are directed out of the pricing process at step 210, and into the bundling process of FIG. 3 at step 304.

The mail pieces that are eligible for FSS preparation are grouped to create FSS Scheme bundles at step 306, and each bundle is evaluated to determine if the bundle can be placed on a pallet at step 308. If the bundles can be placed on a pallet, the bundles are grouped to create FSS Scheme pallets at step 310. If the bundles cannot be placed on a pallet, the bundles are grouped to create FSS sacks at step 312 and each FSS sack is evaluated to determine if the FSS sack meets a minimum requirement for an FSS sack at step 314 and if so, is used to create FSS Scheme pallets at step 310. At step 312, the system may implement the same process for creating FSS Scheme Sacks and FSS Facility sacks, wherein FSS Facility sacks are optional.

Each FSS Scheme pallet is evaluated to determine if the pallet meets a minimum requirement for an FSS Scheme pallet at step 316 and if not, is used to create FSS Facility pallets at step 318 which are evaluated to determine if the pallet meets a minimum requirement for an FSS Facility pallet at step 320. If the pallet does not meet a minimum requirement for an FSS Facility pallet, it is mixed with FSS and non-FSS bundles at step 322, along with FSS sacks that do not meet a minimum requirement for an FSS Scheme pallet.

The mail pieces that are not eligible for FSS preparation are grouped to create non-FSS bundles at step 324, and the non-FSS bundles and FSS bundles are combined at step 322. The combined non-FSS bundles and FSS bundles are evaluated to determine if the bundles can be placed on a pallet at step 326. If the bundles can be placed on a pallet, the bundles are grouped to create pallets at step 328. If the bundles cannot be placed on a pallet, the bundles are grouped to create sacks at step 330 and each sack is used to create pallets at step 328. A more detailed description of the bundling process is shown in FIGS. 4-6.

By orderly implementing a filtering operation wherein FSS and Non-FSS pieces are first identified, followed by a pricing operation for groups with a very granular level (HDP) and the best price, to groups with a very coarse level (3D), and then creating bundles, sacks and pallets of the FSS and Non-FSS pieces based thereon, the system and method identifies the best possible pricing for a mailing, while ensuring that the final mailing is compliant with U.S. Postal Service, Domestic Mail Manual, Section 705.

By using such a system and method, a customer gets the best possible price for the mailing, which is also USPS compliant. Further, efficiency is maximized by setting aside the FSS bundles that could not fit in FSS containers and then combining them with non FSS bundles in the right containers.

FIGS. 4A and 4B is a flow chart illustrating more specifically an FSS preparation process according to an embodiment of the disclosed subject matter. A total number of mail pieces that are eligible for FSS preparation are directed into the process 400 of FIGS. 4A and 4B at step 402. The invention determines if the sort is requested for standard mail, periodical mail, or BPM machinable flats of mail at step 404 and if so, the invention then evaluates each piece for FSS qualifications at step 410. If not, the invention determines that no sort changes are needed at step 406 and ends the process at step 408.

If the mail qualifies, the invention determines if the pieces are periodical mailings at step 412 and if not, determines if the pieces qualify for saturation rates or DDU preparation at step 414. If the pieces are periodical mailings, the invention determines if the pieces are In-Firm bundles at step 416 and if so, moves the pieces into non-FSS groups at step 418. For remaining pieces, the invention then determines if there are less than 5000 pieces in the mailing or if the pieces are addressed In-County at step 420 and if not, again determines if the pieces qualify for saturation rates or DDU preparation at step 414. For remaining pieces, the invention then determines if the user opts for FSS preparation at step 422 and if so, again determines if the pieces qualify for saturation rates or DDU preparation at step 414. If the user does not opt for FSS preparation, the invention again moves the pieces into non-FSS groups at step 418.

If the pieces qualify for saturation rates or DDU preparation, the invention again moves the pieces into non-FSS groups at step 418. If not, the invention determines if the pieces are in L006 at step 428 and if not, the invention again moves the pieces into Non-FSS groups at step 418. L006 describes the required 5-digit Flats Sequencing System scheme sortation list.

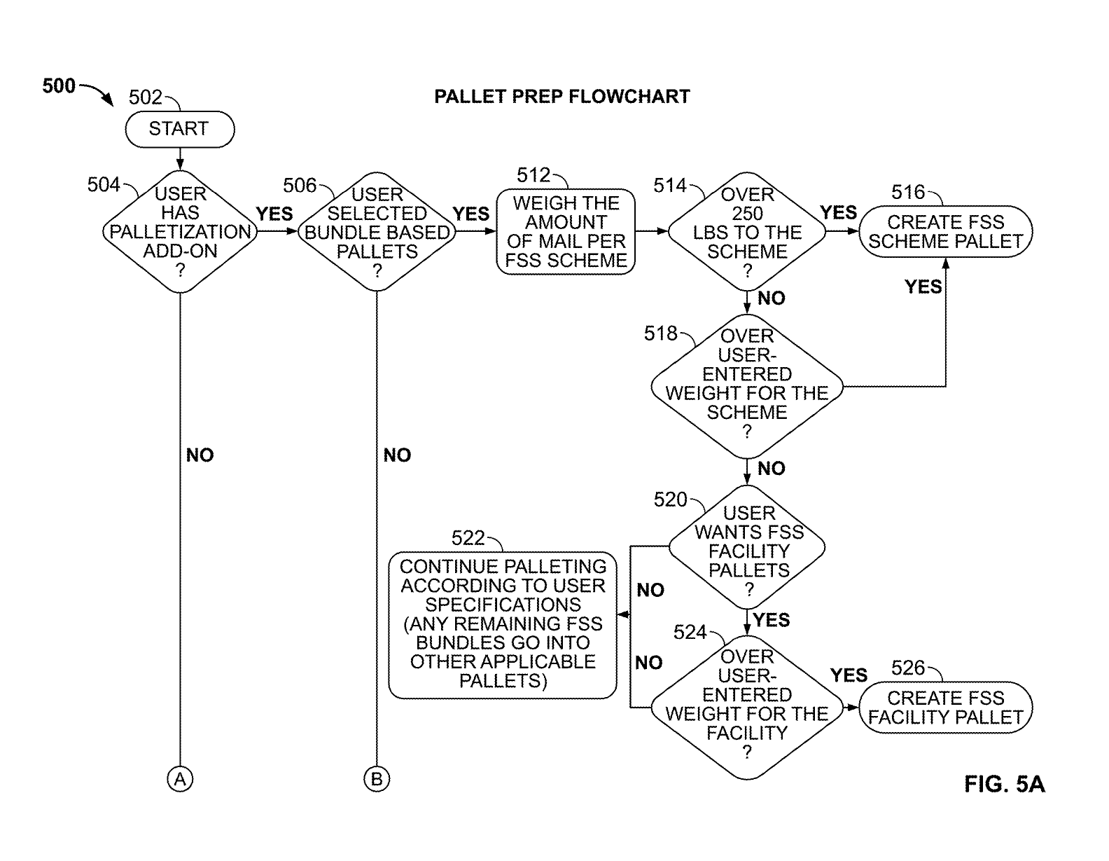

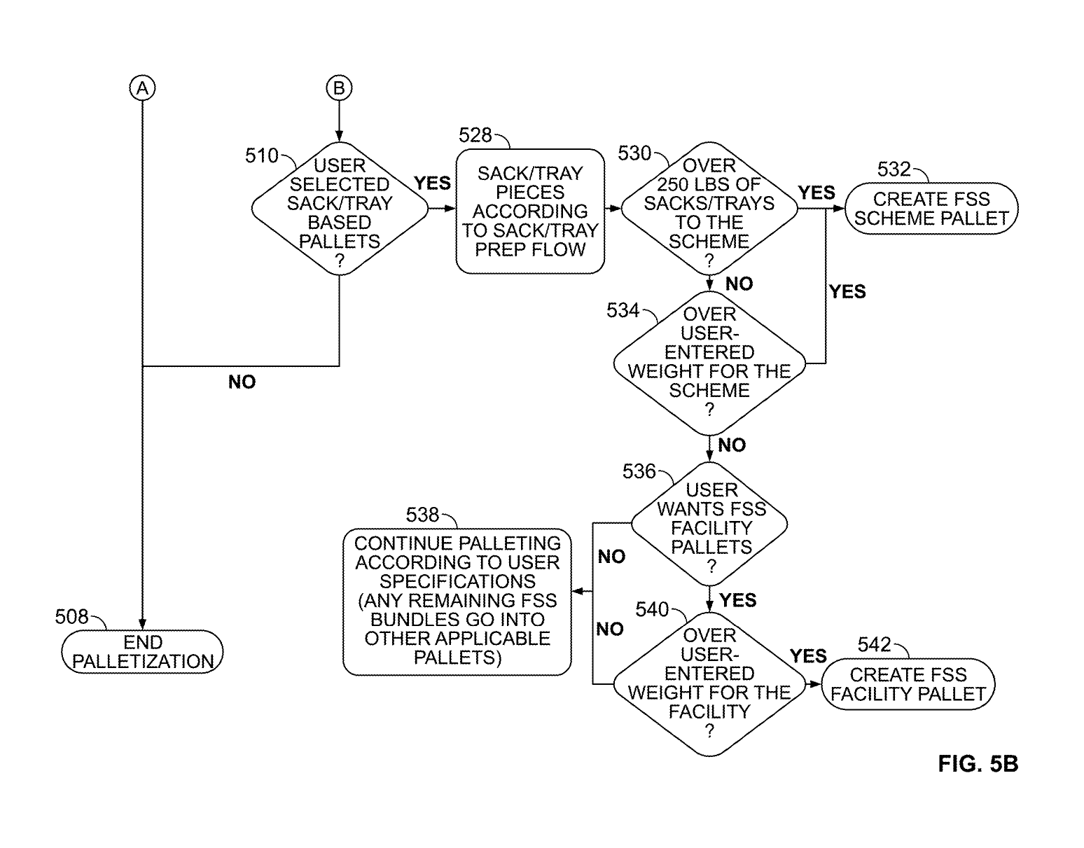

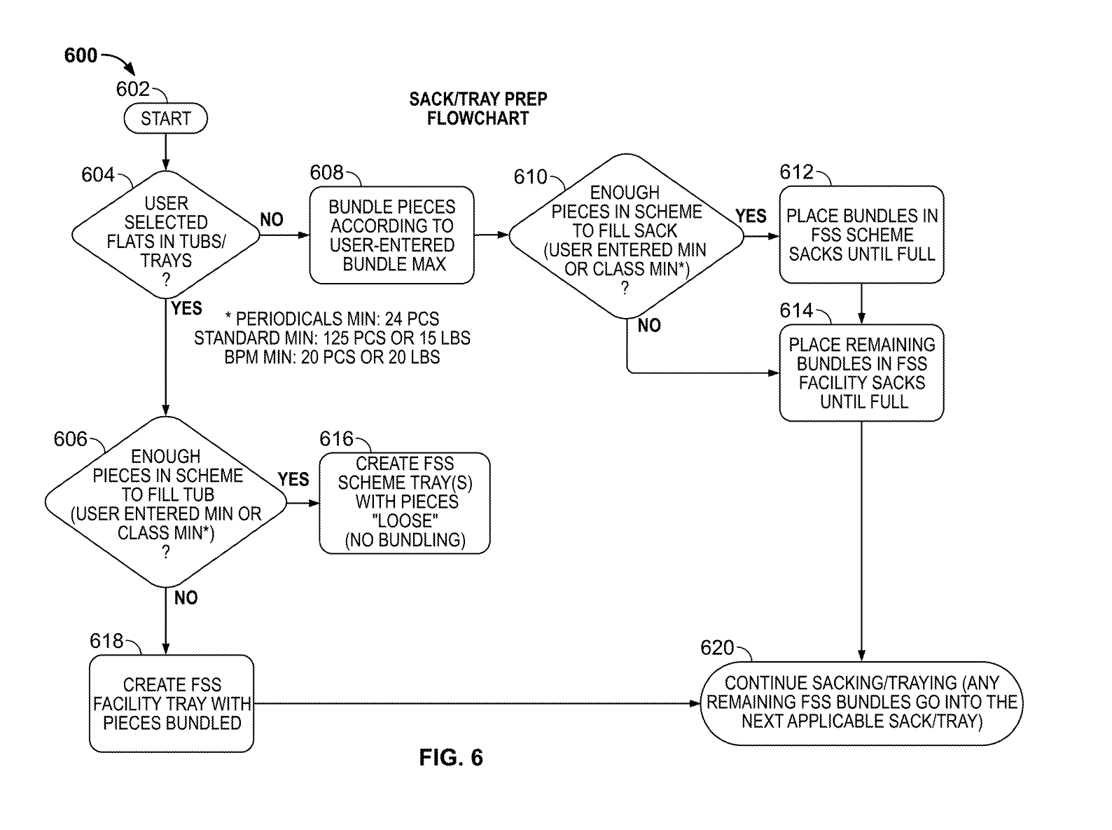

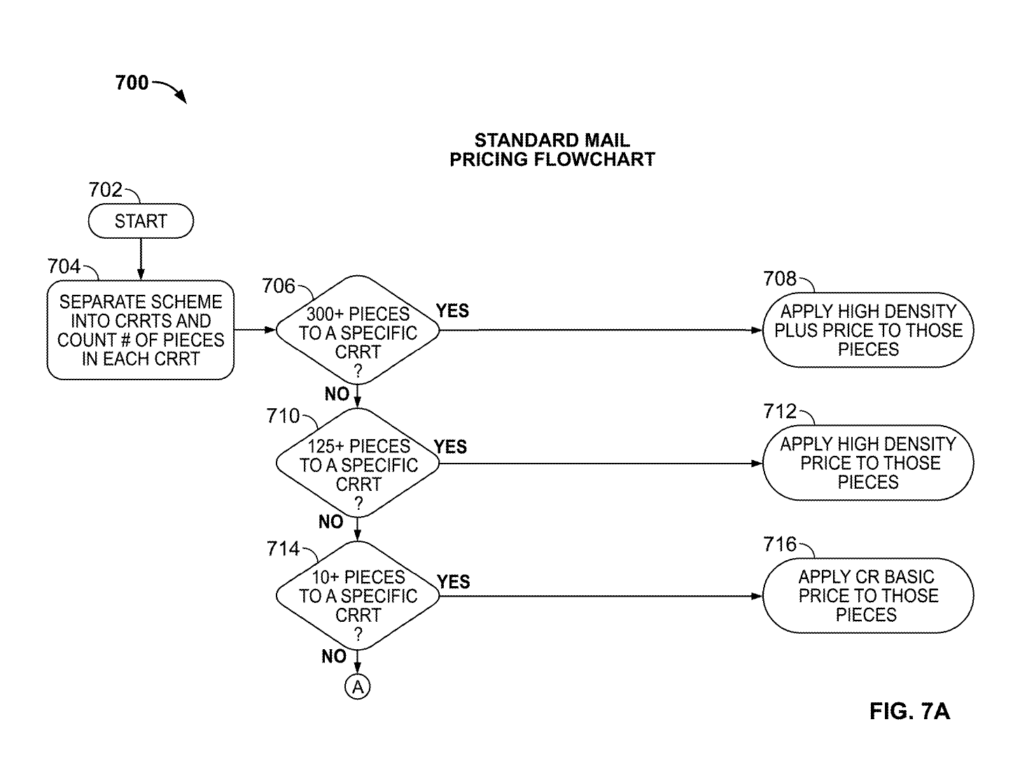

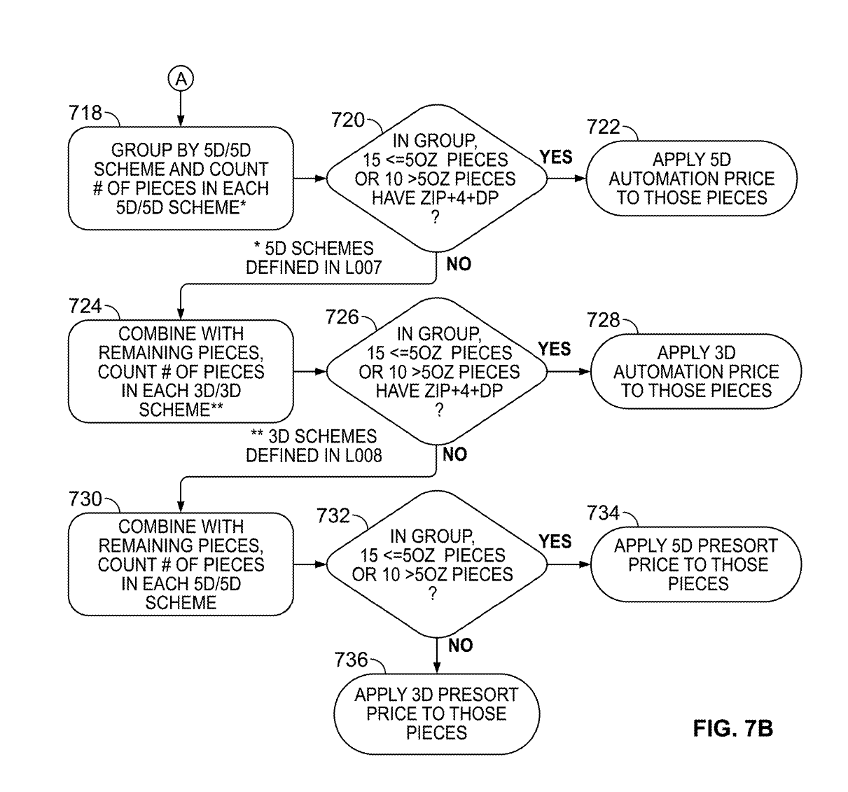

If the pieces are in L006, the invention groups the FSS addresses by L006 Column B at step 430, and determines if the groups meet class minimum requirements at step 432. If the groups meet class minimum requirements, the invention applies pricing at step 434 as described in greater detail in FIGS. 7-11. The invention then separates groups into bundles at step 436 based on maximum bundle thickness values set by the user, for example, 3 to 6.5 inches; gathers groups into pallets at step 438 as described in greater detail in FIGS. 5A and 5B; and gathers groups into sacks at step 440 as described in greater detail in FIG. 6. The remaining pieces are moved into non-FSS groups at step 418 and sorted without changes at step 424. These pieces and those of the bundles, pallets and sacks are combined and ordered by ZIP code at step 426 for quality reporting and piece sequencing, prior to completion at step 408.

FIGS. 5A and 5B is a flow chart illustrating more specifically a detailed pallet preparation process according to an embodiment of the disclosed subject matter. A total number of mail pieces that are eligible for pallet preparation are directed into the process 500 of FIGS. 5A and 5B at step 502. The invention determines if the user has palletization add-on at step 504 and if so, the invention then determines if the user has selected bundle based pallets at step 506. If the user does not have palletization add-on, the invention ends the palletization process at step 508. Also, if the user has not selected bundle based pallets, the invention determines if the user has selected sack and/or tray based pallets at step 510.

If the user has selected bundle based pallets, the invention weighs the amount of mail per FSS Scheme at step 512, and if there is over 250 pounds to the scheme detected at step 514, the invention creates FSS Scheme pallets at step 516. For the remaining pieces, the invention then determines if the pieces are over the user-entered weight for the scheme at step 518 and if so, the invention again creates FSS Scheme pallets at step 516. For the remaining pieces, the invention then determines if the user wants FSS Facility pallets at step 520 and if not, the invention continues palleting according to user's specifications, wherein any remaining FSS bundles go into other applicable pallets at step 522. If the user wants FSS Facility pallets, the invention then determines if the pieces are over user-entered weights for the facility at step 524 and if so, the invention then creates FSS Facility pallets at step 526.

If the user has selected sack and/or tray based pallets at step 510, the invention then sacks and/or trays pieces according to sack and/or tray preparation processes at step 528, and as described in greater detail in FIG. 6. If the user has not selected sack and/or tray based pallets, the invention ends the palletization process at step 508.

The invention weighs the amount of mail per Scheme at step 530, and if there is over 250 pounds to the scheme detected at step 530, the invention creates FSS Scheme pallets at step 532. For the remaining pieces, the invention then determines if the pieces are over the user-entered weight for the scheme at step 534 and if so, the invention again creates FSS Scheme pallets at step 532. For the remaining pieces, the invention then determines if the user wants FSS Facility pallets at step 536 and if not, the invention continues palleting according to user's specifications, wherein any remaining FSS bundles go into other applicable pallets at step 538. If the user wants FSS Facility pallets, the invention then determines if the pieces are over user-entered weights for the facility at step 540 and if so, the invention then creates FSS Facility pallets at step 542.

FIG. 6 is a flow chart illustrating more specifically a detailed sack and/or tray preparation process according to an embodiment of the disclosed subject matter. A total number of mail pieces that are eligible for sack and/or tray preparation are directed into the process 600 of FIG. 6 at step 602. The invention determines if the user has selected flats in tubs and/or trays at step 604 and if so, the invention then determines if there are enough pieces in the scheme to fill a tub at step 606, including user entered minimums and class minimums. If the user has not selected flats in tubs and/or trays at step 604, the invention bundles the pieces according to user-entered bundle maximum size values at step 608. The invention determines if there are enough pieces in the scheme to fill sacks at step 610, including user entered minimums or class minimums and if so, the invention places bundles in FSS Scheme sacks until full at step 612. If there are not enough pieces in the scheme to fill sacks at step 610, including user entered minimums or class minimums, the invention places the remaining bundles in FSS Facility Sacks, with the FSS Scheme Sacks, until full at step 614.

If there are enough pieces in the scheme to fill a tub at step 606, the invention creates FSS Scheme trays with loose pieces, excluding bundling, at step 616. If there are not enough pieces in the scheme to fill a tub at step 606, the invention creates FSS Facility trays with bundles pieces at step 618. Finally, the invention continues sacking and traying any remaining FSS Bundles into the next applicable sack and/or tray at step 620.

FIGS. 7A and 7B is a flow chart illustrating more specifically a detailed pricing process for standard mail according to an embodiment of the disclosed subject matter. A total number of mail pieces that are eligible for standard mail pricing are directed into the process 700 of FIGS. 7A and 7B at step 702. A total number of mail pieces that are eligible are separated into Carrier Routes (CRRTs) at step 704 of process 700, and the invention counts the number of pieces in each CRRT. The invention then determines if there are 300 or more pieces to a specific CRRT at step 706 and if so, the invention applies High-Density Plus prices to those pieces at step 708. For the remaining pieces, the invention then determines if there are 125 or more pieces to a specific CRRT at step 710 and if so, the invention applies High-Density prices to those pieces at step 712. For the remaining pieces, the invention then determines if there are 10 or more pieces to a specific CRRT at step 714 and if so, the invention applies CR Basic prices to those pieces at step 716.

The invention then groups the remaining pieces into 5D/5D schemes at step 718 of process 700, and the invention counts the number of pieces in each 5D/5D scheme. The invention then determines if there are 15 or more pieces that are 5 ounces or less, or if there are 10 or more pieces that are greater than 5 ounces, that have ZIP+4+DP at step 720 and if so, the invention applies 5D automation prices at step 722. For the remaining pieces, the invention then combines the remaining pieces at step 724, and counts the number of pieces in each 3D/3D scheme. The invention then determines if there are 15 or more pieces that are 5 ounces or less, or if there are 10 or more pieces that are greater than 5 ounces, that have ZIP+4+DP at step 726 and if so, the invention applies 3D automation prices at step 728. For the remaining pieces, the invention then combines the remaining pieces at step 730, and counts the number of pieces in each 5D/5D scheme. The invention then determines if there are 15 or more pieces that are 5 ounces or less, or if there are 10 or more pieces that are greater than 5 ounces at step 732 and if so, the invention applies 5D presort prices at step 734. For any remaining pieces, the invention applies 3D pre-sort prices to those pieces at step 736.

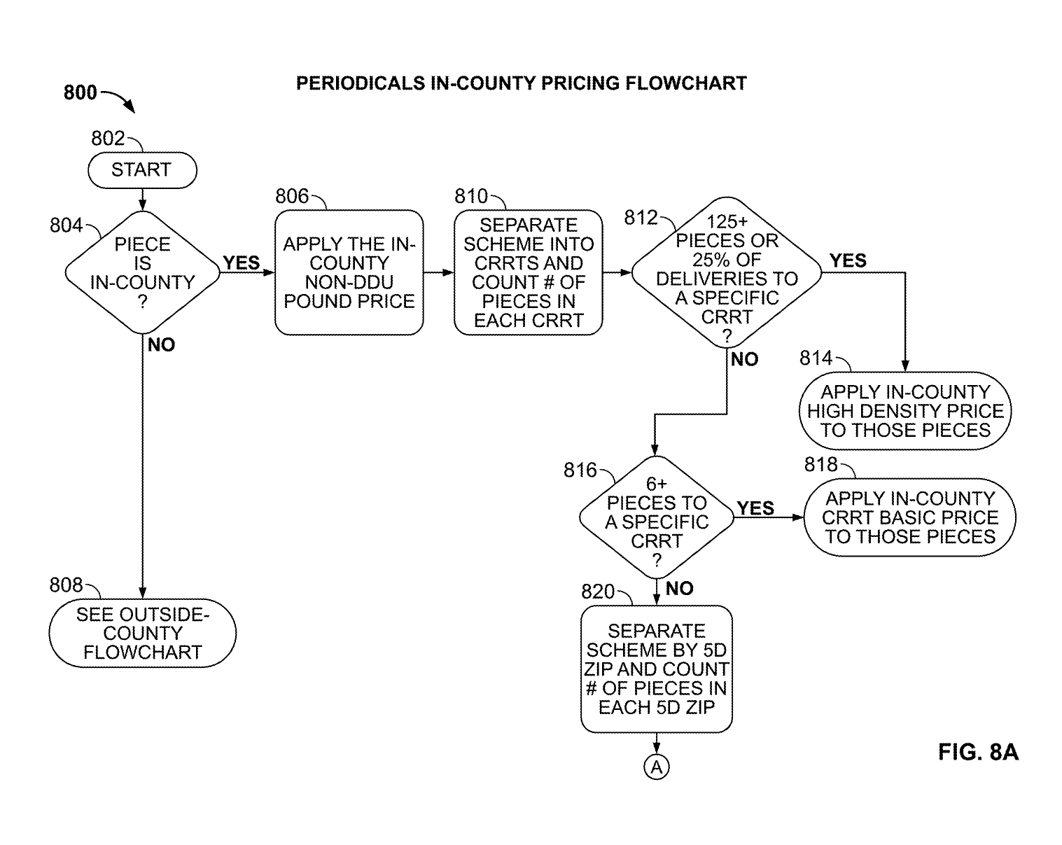

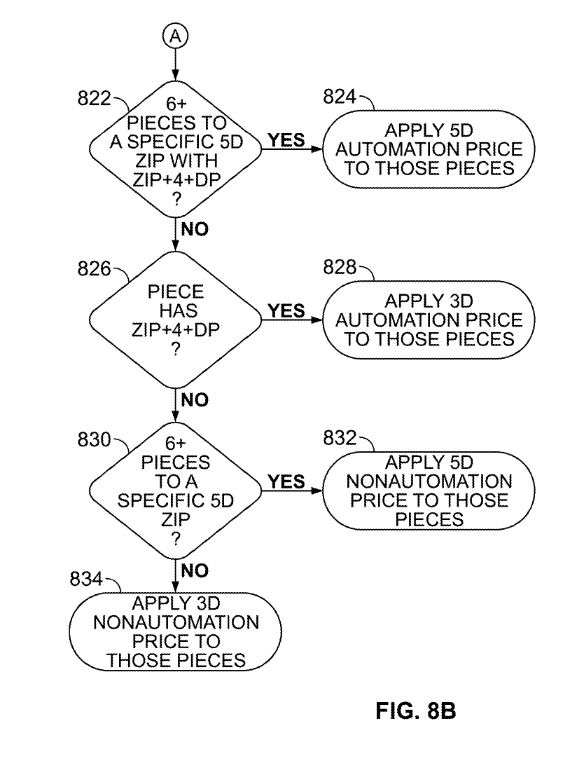

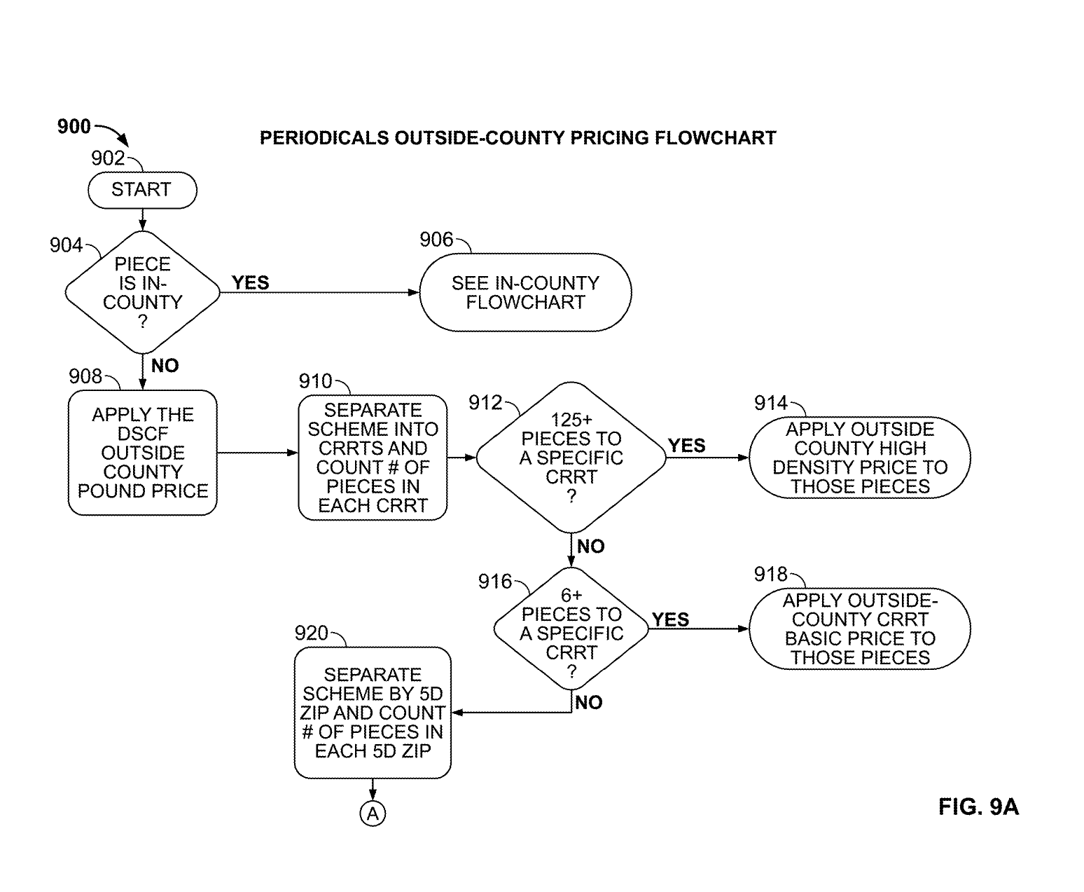

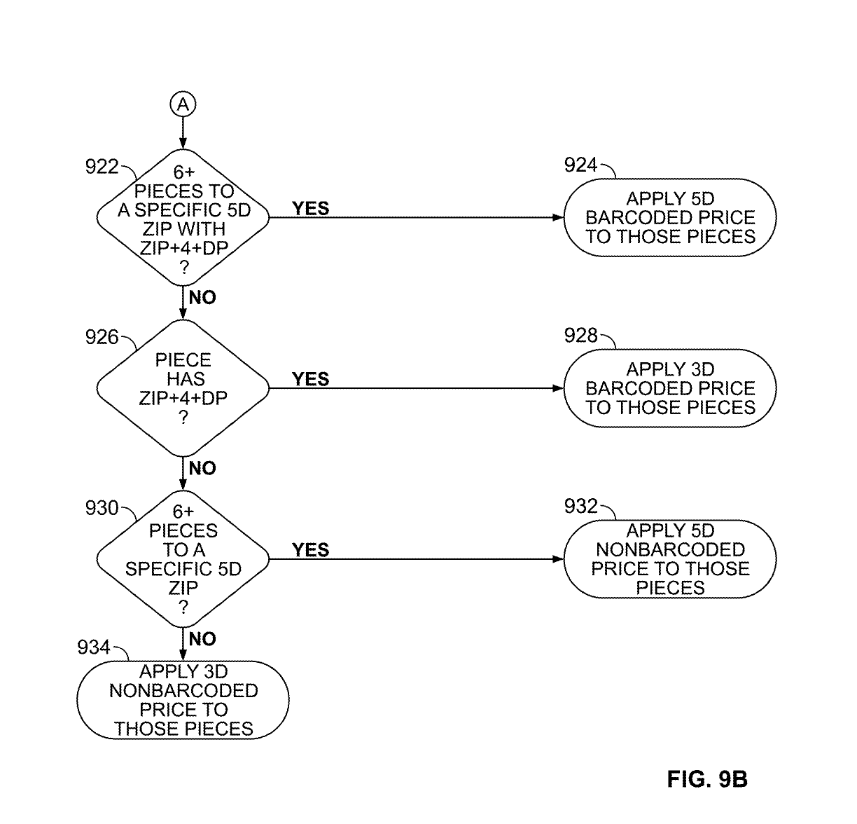

FIGS. 8A and 8B is a flow chart illustrating more specifically a detailed pricing process for periodicals addressed In-County according to an embodiment of the disclosed subject matter. A total number of mail pieces that are eligible for periodicals addressed In-County are directed into the process 800 of FIGS. 8A and 8B at step 802. If the mail pieces are found to be addressed Outside-County at step 804, the mail pieces are directed into the process 900 of FIGS. 9A and 9B at step 808. If the mail pieces are found to be addressed In-County at step 804, the invention applies the In-County, non-DDU pound price at step 806. A total number of mail pieces that are eligible are separated into CRRTs at step 810 of process 800, and the invention counts the number of pieces in each CRRT. The invention then determines if there are 125 or more pieces or if 25 percent of deliveries are to a specific CRRT at step 812 and if so, the invention applies In-County, High-Density prices to those pieces at step 814. The invention then determines for the remaining pieces if there are 6 or more pieces to a specific CRRT at step 816 and if so, the invention applies In-County, CRRT Basic prices to those pieces at step 818.

A total number of remaining mail pieces that are eligible are separated by 5D ZIP at step 820 of process 800, and the invention counts the number of pieces in each 5D ZIP. The invention then determines if there are 6 or more pieces to a specific 5D ZIP with ZIP+4+DP at step 822 and if so, the invention applies 5D automation prices to those pieces at step 824. The invention then determines for the remaining pieces if any piece has ZIP+4+DP at step 826 and if so, the invention applies 3D automation prices to those pieces at step 828. The invention then determines for the remaining pieces if there are 6 or more pieces to a specific 5D ZIP at step 830 and if so, the invention applies 5D non-automation prices to those pieces at step 832. For any remaining pieces, the invention applies 3D non-automation prices to those pieces at step 834.

FIGS. 9A and 9B is a flow chart illustrating more specifically a detailed pricing process for periodicals addressed Outside-County according to an embodiment of the disclosed subject matter. A total number of mail pieces that are eligible for periodicals addressed Outside-County are directed into the process 900 of FIGS. 9A and 9B at step 902. If the mail pieces are found to be addressed In-County at step 904, the mail pieces are directed into the process 800 of FIGS. 8A and 8B at step 906. If the mail pieces are found to be addressed Outside-County at step 904, the invention applies the DSCF Outside-County pound price at step 908. A total number of mail pieces that are eligible are separated into CRRTs at step 910 of process 900, and the invention counts the number of pieces in each CRRT. The invention then determines if there are 125 or more pieces to a specific CRRT at step 912 and if so, the invention applies Outside-County, High-Density prices to those pieces at step 914. The invention then determines for the remaining pieces if there are 6 or more pieces to a specific CRRT at step 916 and if so, the invention applies Outside-County CRRT Basic prices to those pieces at step 918.

A total number of remaining mail pieces that are eligible are separated by 5D ZIP at step 920 of process 900, and the invention counts the number of pieces in each 5D ZIP. The invention then determines if there are 6 or more pieces to a specific 5D ZIP with ZIP+4+DP at step 922 and if so, the invention applies 5D barcoded prices to those pieces at step 924. The invention then determines for the remaining pieces if any piece has ZIP+4+DP at step 926 and if so, the invention applies 3D barcoded prices to those pieces at step 928. The invention then determines for the remaining pieces if there are 6 or more pieces to a specific 5D ZIP at step 930 and if so, the invention applies 5D barcoded prices to those pieces at step 932. For any remaining pieces, the invention applies 3D non-barcoded prices to those pieces at step 934.

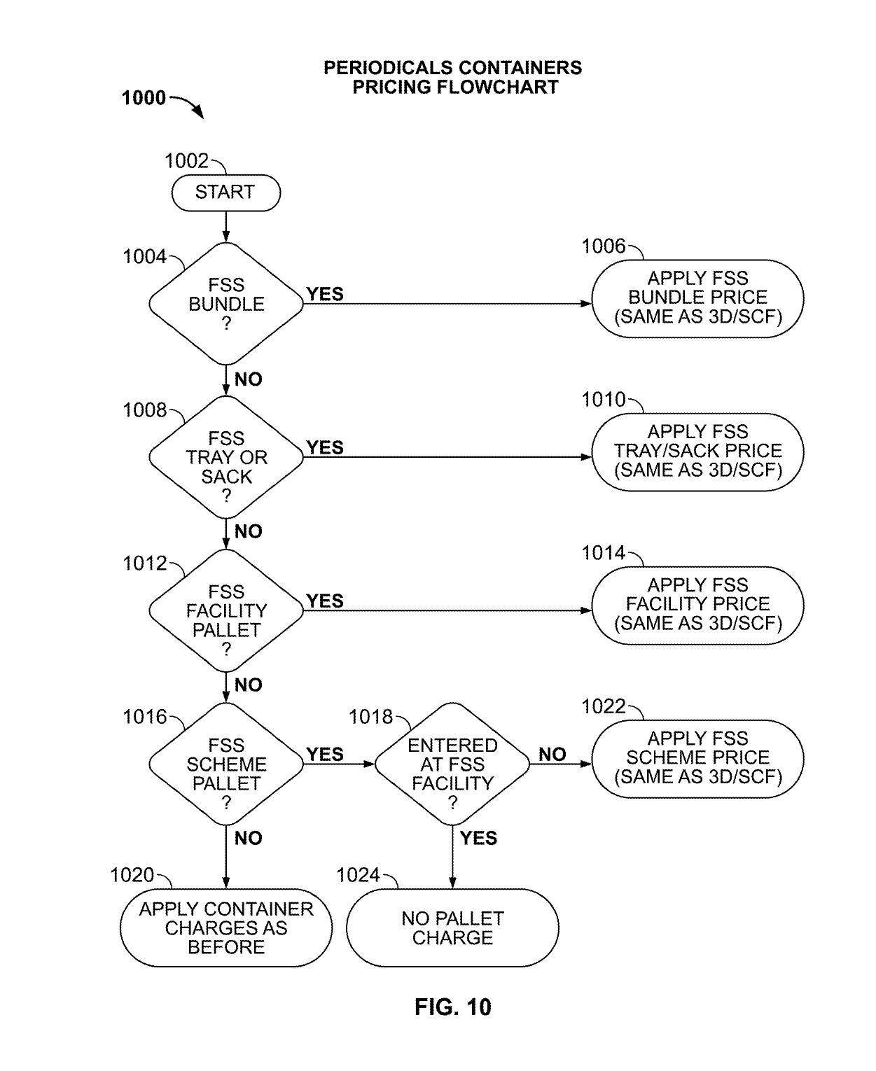

FIG. 10 is a flow chart illustrating more specifically a detailed pricing process for periodicals containers according to an embodiment of the disclosed subject matter. A total number of mail pieces that are eligible for periodicals containers are directed into the process 1000 of FIG. 10 at step 1002. If the mail pieces are found to be in FSS bundles at step 1004, the invention applies FSS bundle prices, the same as 3D/SCF, at step 1006. If the remaining mail pieces are found to be in FSS trays and/or sacks at step 1008, the invention applies FSS tray/sack prices, the same as 3D/SCF, at step 1010. If the remaining mail pieces are found to be in FSS Facility pallets at step 1012, the invention applies FSS Facility prices, the same as 3D/SCF, at step 1014. If the remaining mail pieces are found to be in FSS Scheme pallets at step 1016, the invention determines if the FSS Scheme pallets are entered at an FSS facility at step 1018. The invention applies container charges as before to any remaining mail pieces. If the FSS Scheme pallets are not entered at an FSS facility, the invention applies FSS Scheme prices, the same as 3D/SCF, at step 1022. If the FSS Scheme pallets are entered at an FSS facility, the invention applies no pallet charge at step 1024. Additional processes or process modifications may be provided to reflect container pricing for a 5-digit pallet that contains only carrier bundles.

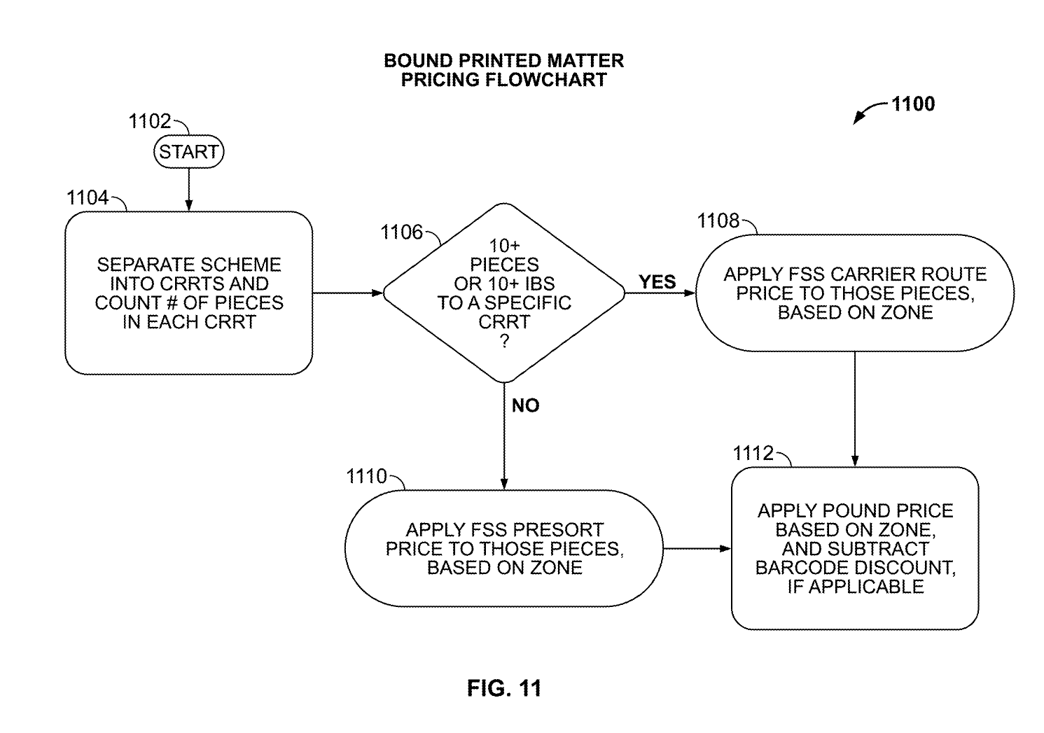

FIG. 11 is a flow chart illustrating more specifically a detailed pricing process for bound printed matter according to an embodiment of the disclosed subject matter. A total number of mail pieces that are eligible for bound printed matter pricing are directed into the process 1100 of FIG. 11 at step 1102. A total number of mail pieces that are eligible are separated into CRRTs at step 1104 of process 1100, and the invention counts the number of pieces in each CRRT. The invention then determines if there are 10 or more pieces or 10 or more pounds to a specific CRRT at step 1106 and if so, the invention applies FSS Carrier Route prices to those pieces based on zone at step 1108. Otherwise, the invention applies FSS Presort prices to those pieces, based on Zone at step 1110, and for both, the invention then applies pound price based on zone and subtracts any barcode discounts if applicable. Where FSS Carrier Route Pricing and FSS Presort pricing are not available, FSS Barcoded and FSS Non-Barcoded pricing may be used if applicable.

By first performing a filtering process to separate FSS and non-FSS eligible pieces and then grouping pieces prior to actual physical grouping, the present invention can determine an optimum price before actually creating the physical groups, thereby taking advantage of both price arrangements and grouping arrangements that best fit the situation.

Embodiments of the disclosed subject matter can further address issues arising in real postal operations. For example, FSS Preparation and optimizing postage is typically a balance between bundle size and production realities. In Periodicals, to truly optimize postage the system directs the creation of 6 inch bundles because one component of the total postage cost is the number of bundles created for the mailing. However, the reality of processing FSS bundles is that 6 inch bundles are likely to break during processing, and bundle breakage adds significant cost to the Postal Service. Accordingly, embodiments of the disclosed subject matter can further optimize postage by directing the creation of 6 inch FSS bundles when the bundles are put onto an FSS Scheme pallet or container. These FSS bundles will go straight to the FSS machine and avoid USPS bundle processing where breakage occurs. After the FSS scheme pallet or containers are made, the system may be directed to unbundle and rebundle the remaining FSS bundles at a smaller bundle thickness (generally 4 inches). In doing so, embodiments of the disclosed subject matter can further create the optimum balance between minimizing postage and minimizing bundle breakage.

Various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method to sort mail into physical groups having optimum prices, comprising:
controlling an intake operation to separate Flat Sequence Sorter (FSS) and non-FSS eligible mail pieces;
controlling a sorting operation to selectively group the sorted pieces prior to actual physical grouping;
controlling a pricing operation to determine an optimum price before actually creating the physical groups of sorted pieces, wherein the selective grouping of the sorted pieces is varied to provide the optimum price for the physical groups; and
controlling the sorting operation to create the physical groups in response to the pricing operation.

2. The method of claim 1, wherein at least one physical group includes both FSS and non-FSS eligible pieces.

3. The method of claim 1, wherein the non-FSS eligible pieces comprise Walk Sequence Saturation pieces, Destination Delivery Unit (DDU) pieces, Firm Bundle pieces and In-County pieces.

4. The method of claim 1, wherein the pricing operation determines an optimum price by sequential calculation from a granular level to a coarse level for the FSS eligible mail pieces.

5. The method of claim 1, wherein the sorting operation selectively creates the groups for optimum pricing by including the FSS eligible pieces and excluding non-FSS eligible pieces that do not comply with a minimum requirement for the physical groups.

6. The method of claim 5, wherein the sorting operation creates the physical groups by combining the non-FSS eligible pieces with the FSS eligible pieces, such that the combination complies with a minimum requirement for the physical groups.

7. The method of claim 1, wherein the physical groups comprise one or more of an FSS Scheme pallet, and FSS Facility pallet, and an FSS Sack.

8. A system to sort mail into physical groups having optimum prices, comprising:
an intake operator, configured to separate Flat Sequence Sorter (FSS) and non-FSS eligible mail pieces;
a sorting operator, configured to selectively group the sorted pieces prior to actual physical grouping;
a pricing operator, configured to determine an optimum price before actually creating the physical groups of sorted pieces, wherein the selective grouping of the sorted pieces is varied to provide the optimum price for the physical groups; and
the sorting operator further configured to create the physical groups in response to the pricing operation.

9. The system of claim 8, wherein at least one physical group includes both FSS and non-FSS eligible pieces.

10. The system of claim 8, wherein the non-FSS eligible pieces comprise Walk Sequence Saturation pieces, Destination Delivery Unit (DDU) pieces, Firm Bundle pieces and In-County pieces.

11. The system of claim 8, wherein the pricing operator determines an optimum price by sequential calculation from a granular level to a coarse level for the FSS eligible mail pieces.

12. The system of claim 8, wherein the sorting operator selectively creates the groups for optimum pricing by including the FSS eligible pieces and excluding non-FSS eligible pieces that do not comply with a minimum requirement for the physical groups.

13. The system of claim 12, wherein the sorting operator creates the physical groups by combining the non-FSS eligible pieces with the FSS eligible pieces, such that the combination complies with a minimum requirement for the physical groups.

14. The system of claim 8, wherein the physical groups comprise one or more of an FSS Scheme pallet, and FSS Facility pallet, and an FSS Sack.
